(19) United States
(12) Patent Application Publication
(10) Pub. No.: US 2004/0217044 A1
(43) Pub. Date: Nov. 4, 2004

(54) Sealing arrangement

(76) Inventors: Paul Gill, London (GB); Richard William Adams, Hertfordshire (GB)

Correspondence Address: SMITH-HILL AND BEDELL, 12670 N W BARNES ROAD, SUITE 104, PORTLAND, OR, 97229

(21) Appl. No.: 10/793,991

(22) Filed: Mar. 4, 2004

(30) Foreign Application Priority Data
Mar. 6, 2003 (GB) 0305104.2

(51) Int. Cl. B01D 35/00

(52) U.S. Cl. 210/232

(57) ABSTRACT

A sealing arrangement comprising a first membrane having a periphery and a second membrane comprising a first portion overlying the first membrane and a second portion extending from the first portion, wherein the first membrane is substantially wholly attached to the first portion of the second membrane.

### FIELD OF THE INVENTION

This invention relates to sealing members. More particularly, but not exclusively, the invention relates to sealing members for providing a seal over an aperture, for example over an open top of a container.

### BACKGROUND TO THE INVENTION

Many containers, for example pharmaceutical bottles and milk bottles require a seal over the opening. To open a container, it is necessary to remove or break the seal. This provides an indication as to whether the container has previously been opened or tampered with. Generally, the seals are formed from aluminium foil and are secured to stopper the container by adhesive provided on the foil.

### BRIEF DESCRIPTION OF THE INVENTION

According to one aspect of the present invention there is provided a sealing arrangement comprising a first membrane having a periphery and a second membrane comprising a first portion overlying the first membrane and a second portion extending from the first portion, wherein the first membrane is substantially wholly attached to the first portion of the second membrane.

The second portion of the second membrane may extend beyond the periphery of the first membrane.

According to a further aspect of the present invention, there is provided a sealing arrangement comprising a first membrane having a periphery, and a second membrane comprising a first portion attached to and overlying the first membrane, wherein the second membrane further includes a second portion extending beyond the periphery of the first membrane.

Preferably the first and second membranes each comprise respective opposite edges. In one embodiment, the first and second membranes may be arranged such that one of the edges of each of the first and second membranes coincide with each other. Preferably, the first and second portions together comprise a single element.

The first membrane may comprise a single edge extending around the first membrane. The edge of the first membrane may be substantially circular. The first portion of the second membrane may comprise a single edge arranged in alignment with the edge of the first membrane. The edge of the second membrane may be substantially circular.

In another embodiment, the second membrane may include a third portion which extends beyond the periphery of the first member. The third portion may be arranged opposite the second portion.

Preferably, the first and second membranes are elongate. Preferably, the first membrane is attached to the second membrane substantially along the length of the first and second membranes. Preferably, the first membrane is substantially wholly attached to the first portion of the second membrane.

Preferably, the first membrane and the first portion of the second membrane are arranged in face to face contact with each other.

A layer of adhesive may be provided between the first and second membranes. The adhesive may be a hot melt adhesive,

Preferably, the first and second membranes are in the form of elongate strips.

The first membrane may be a metal foil, for example aluminium foil. The second membrane may be a plastics material, for example a polyester.

The second portion may comprise at least two parts, angled relative to one another. The third portion may comprise at least two parts, angled relative to one another. The second portion may have an aperture.

According to another aspect of the present invention there is provided a sealing arrangement comprising a first membrane and a second membrane, the second membrane comprising a first portion attached to and overlying the first membrane, the second portion extending from the first portion and having an aperture.

According to another aspect of this invention there is provided a method of forming a sealing arrangement comprising providing a first membrane having a periphery, providing a second membrane comprising first and second portions, and arranging the first and second membranes in face to face contact such that the second portion extends beyond the periphery of the first membrane.

In one embodiment, the second membrane may comprise a third portion, and the step of arranging the first and second membranes in face to face contact, may comprise arranging said first and second membranes such that the third portion extends beyond the periphery of the first membrane.

Preferably, the method further includes cutting a sealing member from said sealing arrangement, said sealing member comprising a main part comprising the first and second membranes, and a tab extending beyond said main part, said tab being formed from said second membrane, desirably from the second portion of the second membrane.

In one embodiment, the method may involve cutting said sealing arrangement such that a second tab extends beyond said first part. Preferably, the second tab extends from said main part opposite the first mentioned tab. Preferably, the second tab is formed from the second member, conveniently from the third portion of the second membrane.

According to a further aspect of the present invention there is provided a method of forming a sealing arrangement comprising providing a first membrane and a second membrane, said second membrane comprising first and second portions, arranging the first portion and the first membrane in face to face contact and providing the second portion with an aperture.

Embodiments of the invention will now be described by way of example only, with reference to the accompanying drawings, in which:

### BRIEF DESCRIPTION OF THE DRAWINGS

FIG. 1 shows a side view of one embodiment of a sealing arrangement;

FIG. 2 shows the sealing arrangement of FIG. 1 in which the first membrane is separate from the second membrane;

FIG. 3 is a top plan view of a sealing member formed from the sealing arrangement shown in FIG. 1;

FIG. 4 is a view along the lines IV-IV in FIG. 3;

FIG. 5 shows a side view of a further embodiment of a sealing arrangement;

FIG. 6 shows the sealing arrangement of FIG. 5 in which the first membrane is separate from the second membrane;

FIG. 7 is top plan view of a sealing member formed from the sealing arrangement shown in FIG. 5;

FIG. 8 is a view along the line VIII-VIII in FIG. 7;

FIG. 9 illustrates another embodiment of a sealing arrangement in which the first membrane is separate from the second membrane;

FIG. 10 is a top plan view of the sealing arrangement illustrated in FIG. 9;

FIG. 11 illustrates a further embodiment of a sealing arrangement in which the first membrane is separate from the second membrane;

FIG. 12 is a top plan view of the sealing arrangement illustrated in FIG. 11;

FIG. 13 illustrates another embodiment of a sealing arrangement;

FIG. 14 is a top plan view of the sealing arrangement illustrated in FIG. 13.

### DETAILED DESCRIPTION OF EMBODIMENTS OF THE INVENTION

Referring to FIGS. 1 and 2, there is shown a sealing arrangement 10 which comprises a first membrane 12 in the form of an elongate substantially rectangular strip of aluminium foil, and a second membrane 14 in the form of an elongate substantially rectangular strip of a polyester material. The first membrane 12 comprises a periphery comprising first and second opposite edges 16, 18, and the second membrane has first and second respective opposite edges 20, 22.

The second membrane 14 comprises a first portion 24 which substantially wholly overlies the first membrane 12.

The second membrane 14 also includes a second portion 26 which extends from the main portion 24 beyond the first edge of the first membrane 12. In FIG. 2, a broken line 25 is shown, between the first and second portions 24, 26 of the second membrane 14. This is for the purposes of illustration only. In reality, there will be no such line between the first and second portions 24, 26, because the second membrane 14 is in the form of a one piece elongate strip.

A layer of adhesive 28 is provided between the first and second membranes 12, 14 to attach the first portion 24 of the second membrane to the first membrane 12 substantially wholly along the length of the first membrane 12 and substantially wholly across the width of the first membrane 12 between the first and second opposite edges 16, 18 of the first membrane 12.

A layer of adhesive 29 is provided on the underside of the first membrane 12.

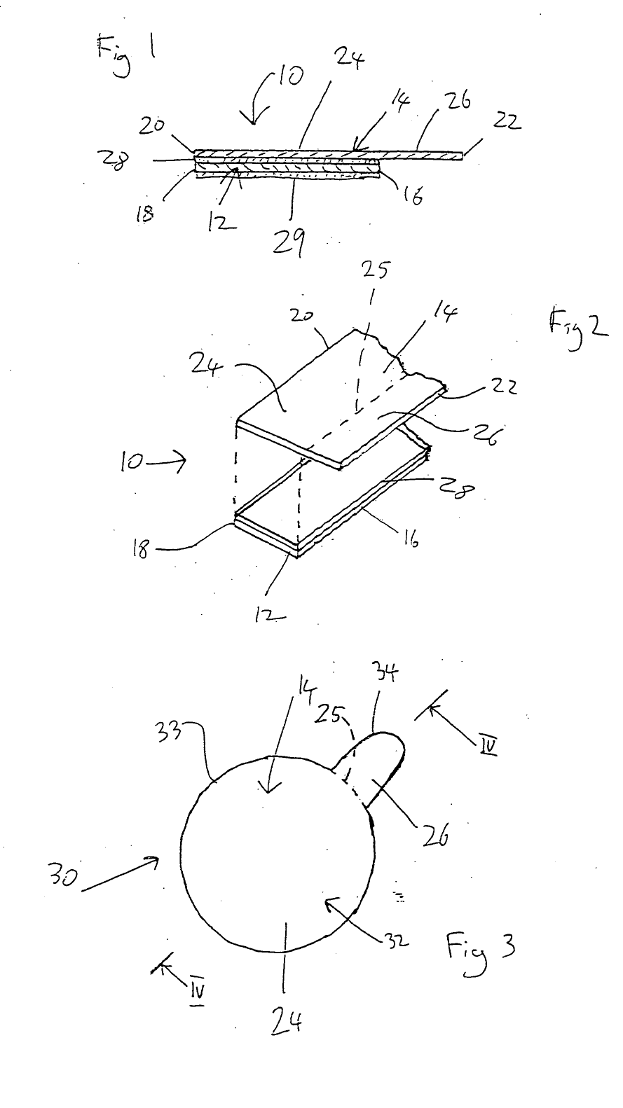

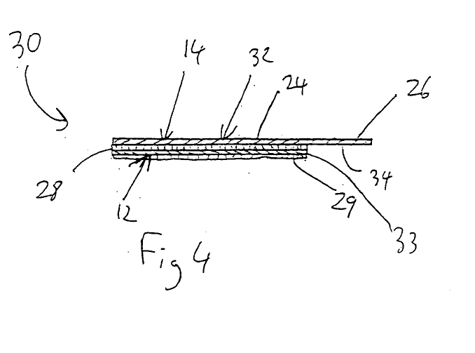

The sealing arrangement 10 can be of any desired length, and is destined to be cut into a plurality of substantially circular sealing members 30, as shown in FIG. 3 and 4. As can be seen, the sealing member 30 has been cut out from the sealing arrangement 10 and has a substantially circular main part 32 comprising the first membrane 12 and the first portion 24 of the second membrane 14 substantially wholly attached to each other by the adhesive 28. The main part 32 has a periphery 33. The sealing member 30 also includes a tab 34 formed from the second portion 26 of the second membrane. The tab 34 extends outwardly from the main part 32.

The sealing member 30 can be cut from the sealing arrangement 10 by the use of an appropriately shaped cutter using known manufacturing machines and known methods of manufacture.

The sealing member 30 is provided with the adhesive 29 on the underside of the first membrane 12 to secure it to the edge of an aperture, for example an open top of a container, by any means known in the art.

In order to remove the sealing member from the container, the user pulls upwardly on the tab 34 thereby peeling the main part 32 away from the container.

Various modifications can be made without departing from the scope of the invention.

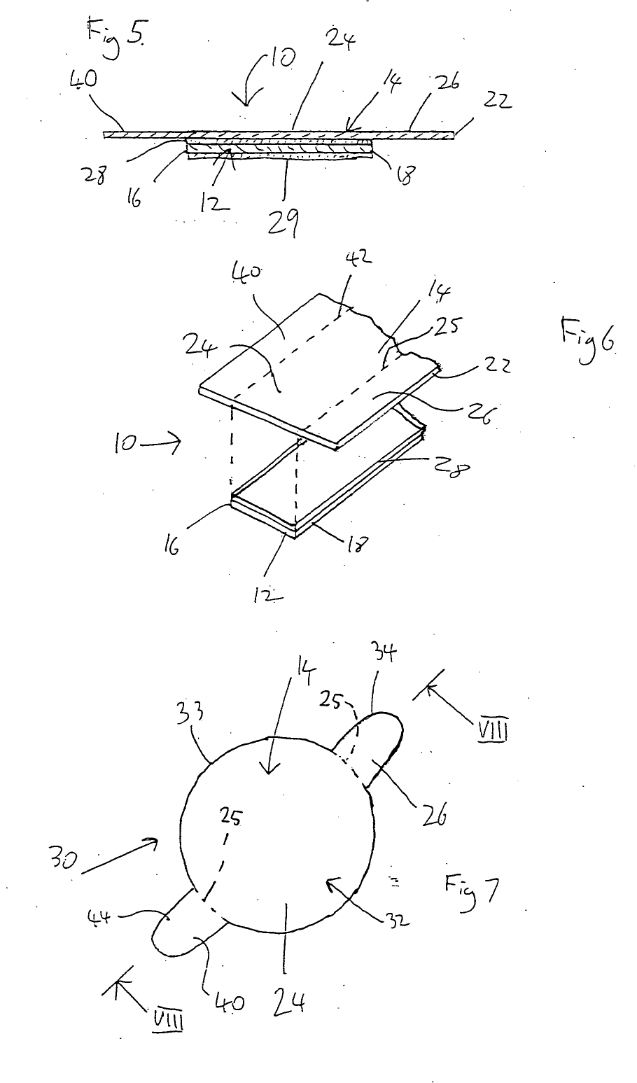

A further embodiment is shown in FIGS. 5 to 8. This embodiment comprises many of the same features as shown in FIGS. 1 to 4, and these features have been designated with the same reference numerals as in FIGS. 1 to 4.

The embodiment shown in FIGS. 5 to 8 differs from the embodiment shown in FIGS. 1 to 4 in that the second membrane 14 includes a third portion 40 which extends from the main portion 24 on the opposite side thereof to the second portion 26. In FIG. 5, a broken line 42 is shown between the third and first portions 40, 24 of the second membrane 14. This is for the purposes of illustration only and, in reality, there will be no such line between the third and first portions 40, 24, because the second membrane 14 is in the form of a one piece elongate strip.

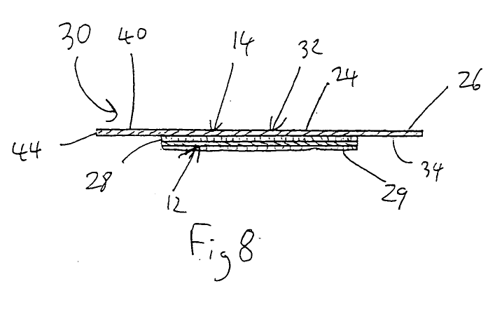

The position of the second portion 40 means that a second tab 44 can be provided on the sealing member 32. The second tab 44 is provided opposite the first tab 34, as shown in FIGS. 7 and 8.

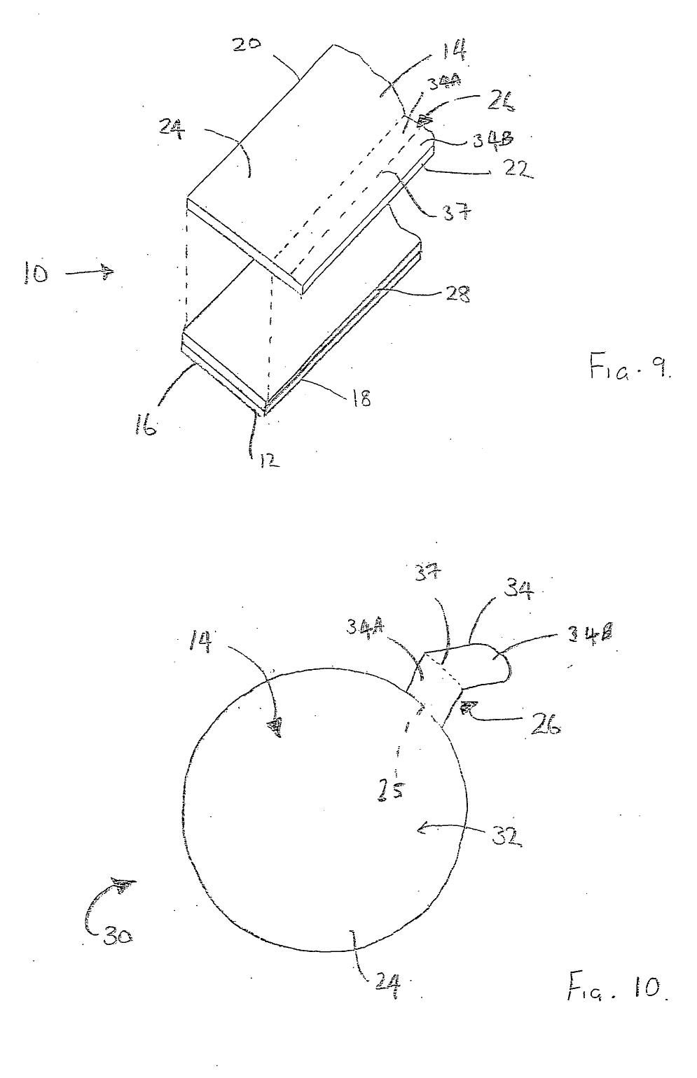

A further embodiment is shown in FIGS. 9 and 10. This embodiment comprises many of the same features as shown in FIGS. 1 to 4, and these features have been provided with the same reference numerals as in FIGS. 1 to 4.

The embodiment illustrated in FIGS. 9 and 10 is similar to the embodiment shown in FIGS. 2 and 3 and the same features have been designated with the same reference numeral. The embodiment shown in FIGS. 9 and 10 differs from the embodiment illustrated in FIGS. 1 to 4 in that the second portion 26 (and hence tab 34) comprises a first part 34A and a second part 34B. In FIGS. 9 & 10, a broken line 37 is shown between the first part 34A and the second part 34B. This is for the purpose of illustration only. The first part 34A is angled relative to the second part 34B. The first and second parts 34A and 34B are, in this example, angled relative to the main part 32.

When the sealing member 30 illustrated in FIG. 10 is applied to a bottle, it may provide a number of advantages. One such advantage is that the tab 34 may retain itself within a screw cap for a bottle. The second part 34B may be inserted into the screw thread of the cap and thereby retain the sealing member 30 within the cap. A further advantage is that when the cap is screwed onto the bottle, the tab 30 may be folded up into contact with the main part 32. This may help to prevent the second portion 26 of the tab 34 entering the bottle when the cap is screwed on.

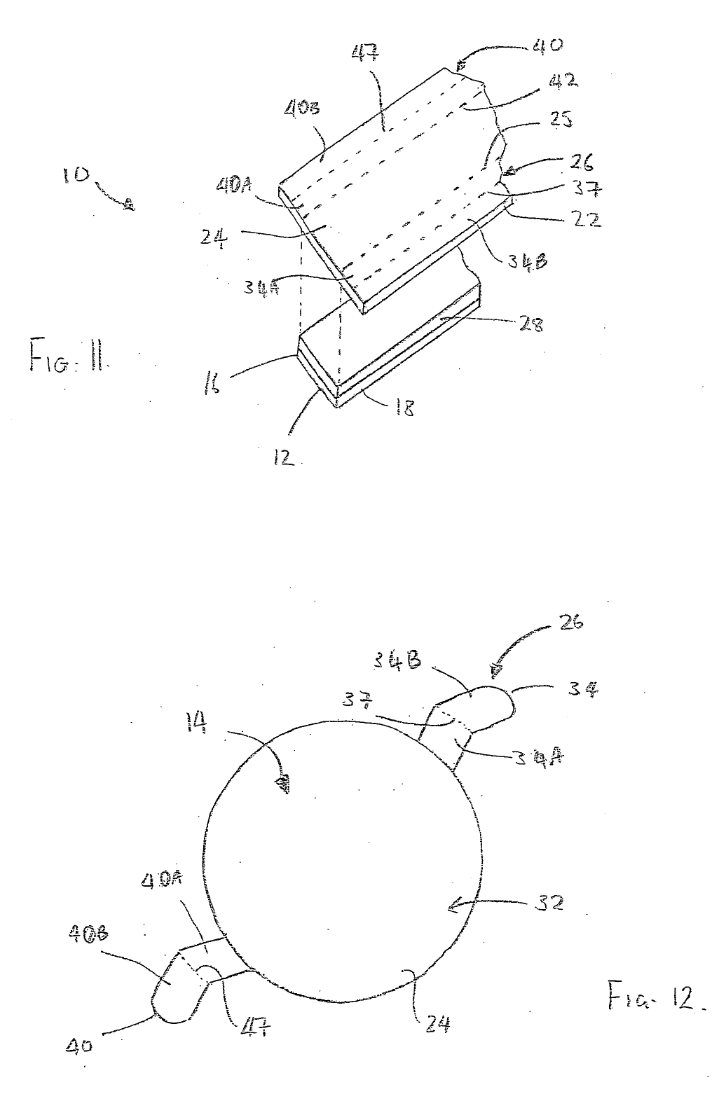

A further embodiment is shown in FIGS. 11 and 12. This embodiment comprises many of the same features as shown in FIGS. 5 to 8, and these features have been provided with the same reference numerals as in FIGS. 5 to 8.

The embodiment illustrated in FIGS. 11 and 12 differs from the embodiment illustrated in FIGS. 5 to 8 in that tabs 34, 40 comprise a first part 34A, 40A and a second part 34B, 40B. In FIGS. 11 & 12, a broken line 37 is shown between the first part 34A and the second part 34B. This is for the purpose of illustration only. The first part 34A is angled relative to the second part 34B. The first and second parts 34A and 34B are, in this example, angled relative to the main part 32. The tab 40 also comprises a first part 40A and a second part 40B. In FIGS. 11 & 12, a broken line 47 is shown between the first part 40A and the second part 40B. This is for the purpose of illustration only. The first part 40A is angled relative to the second part 40B. The first and second parts 40A and 40B are, in this example, angled relative to the main part 32.

The tabs 34 and 40 provide the same advantages as those discussed above with reference to FIGS. 9 & 10.

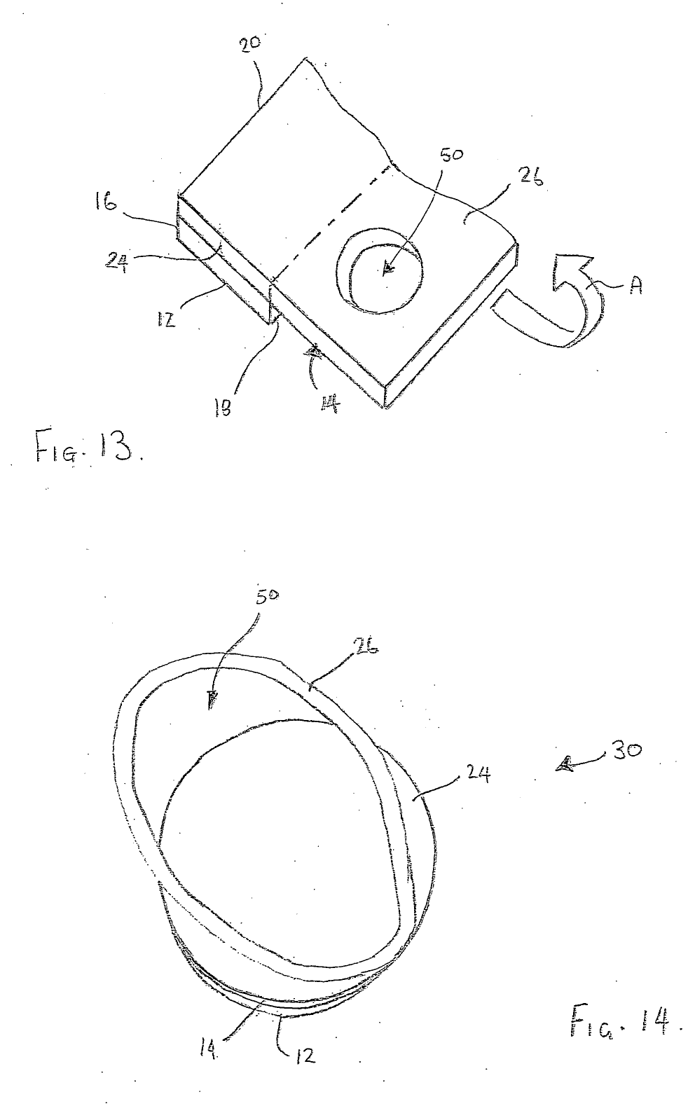

FIGS. 13 & 14 illustrate another embodiment of a sealing arrangement. This embodiment comprises many of the same features as those illustrated in FIGS. 1 to 4 and these features have been provided with the same reference numerals as in FIGS. 1 to 4.

FIG. 13 shows that the second membrane 14 overlies the first membrane 12. The second membrane comprises a first portion 24 and a second portion 26 that extends from the first portion 24. The first portion 24 overlies the first membrane 12. The second portion 26 extends beyond an edge 18 of the first membrane 12.

Sealing member 30, illustrated in FIG. 14, is formed according to the following process. The second portion 26 is provided with a circular aperture 50. The second portion 26 is then folded over the first portion 24 as illustrated by arrow A. A circular section of the first membrane 12 and second membrane 14, centred on the aperture 50, is removed to form the sealing member 30. The embodiment therefore provides a ‘ring pull’ seal 30, as illustrated in FIG. 14 for a container.

There is thus described a sealing arrangement and a sealing member for sealing, for example, the open top of a container, such as a bottle, which is formed by laminating together a first membrane of an aluminium foil with a second membrane of a plastics material, in which the plastic material forms a tab extending outwardly from the periphery of the aluminium foil, thereby allowing the sealing member to be removed from the container. The plastics material may be a polyester material.

An advantage of the embodiments described above is that it enables more efficient induction heating of the aluminium foil so that the adhesive 29 provided on the underside of the first membrane 12. By ensuring that the tabs 34 (or 44) are not formed from a metallic substance, the induction field does not pass into the tab 34 or 44. Thus, there is no weakening of the adhesion of the adhesive 29 to the top of the container as in the case of prior art situations.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A sealing arrangement comprising a first membrane having a periphery and a second membrane comprising a first portion overlying the first membrane and a second portion extending from the first portion, wherein the first membrane is substantially wholly attached to the first portion of the second membrane.

2. A sealing arrangement according to claim 1, wherein the second portion of the second membrane extends beyond the periphery of the first membrane.

3. A sealing arrangement according to claim 1, wherein the first and second membranes each comprise respective opposite edges.

4. A sealing arrangement according to claim 3, wherein the first and second membranes are arranged such that one of the edges of each of the first and second membranes coincide with each other.

5. A sealing arrangement according to claim 1, wherein the first and second portions together comprise a single element.

6. A sealing arrangement according to claim 1, wherein the first membrane comprises a single edge extending around the first membrane.

7. A sealing arrangement according to claim 6, wherein the edge of the first membrane is substantially circular.

8. A sealing arrangement according to claim 6, wherein the first portion of the second membrane comprises a single edge arranged in alignment with the edge of the first membrane.

9. A sealing arrangement according to claim 8, wherein the edge of the second membrane is substantially circular.

10. A sealing arrangement according to claim 1, wherein the second membrane includes a third portion which extends beyond the periphery of the first membrane.

11. A sealing arrangement according to claim 1, wherein the third portion is arranged opposite the second portion.

12. A sealing arrangement according to claim 3, wherein the first and second membranes are elongate.

13. A sealing arrangement according to claim 1, wherein the first membrane is attached to the second membrane substantially along the length of the first and second membranes.

14. A sealing arrangement according to claim 1, wherein the first membrane is substantially wholly attached to the first portion of the second membrane.

15. A sealing arrangement according to claim 1, wherein the first membrane and the first portion of the second membrane are arranged in face to face contact with each other.

16. A sealing arrangement according to claim 1, wherein a layer of adhesive is provided between the first and second membranes.

17. A sealing arrangement according to claim 16, wherein the adhesive is a hot melt adhesive.

18. A sealing arrangement according to claim 1, wherein the first and second membranes are in the form of elongate strips.

19. A sealing arrangement according to claim 1, wherein the first membrane is a metal foil.

20. A sealing arrangement according to claim 19, wherein the first membrane is an aluminium foil.

21. A sealing arrangement according to claim 1, wherein the second membrane is a plastics material.

22. A sealing arrangement according to claim 21, wherein the second membrane is polyester.

23. A sealing arrangement according to claim 1, wherein the second portion comprises at least two parts, angled relative to one another.

24. A sealing arrangement according to claim 1, wherein the third portion comprises at least two parts, angled relative to one another.

25. A sealing arrangement according to claim 1, wherein the second portion has an aperture.

26. A sealing arrangement comprising a first membrane having a periphery, and a second membrane comprising a first portion attached to and overlying the first membrane, wherein the second membrane further includes a second portion extending beyond the periphery of the first membrane.

27. A sealing arrangement comprising a first membrane and a second membrane, the second membrane comprising a first portion attached to and overlying the first membrane, the second portion extending from the first portion and having an aperture.

28. A method of forming a sealing arrangement comprising providing a first membrane having a periphery, providing a second membrane comprising first and second portions, and arranging the first and second membranes in face to face contact such that the second portion extends beyond the periphery of the first membrane.

29. A method according to claim 28, wherein the second membrane comprises a third portion, and the step of arranging the first and second membranes in face to face contact, comprises arranging said first and second membranes such that the third portion extends beyond the periphery of the first membrane.

30. A method according to claim 29, further including cutting a sealing member from said sealing arrangement, said sealing member comprising a main part comprising the first and second membranes, and a tab extending beyond said main part, said tab being formed from said second membrane

31. A method according to claim 30, wherein the tab is formed from the second portion of the second membrane.

32. A method according to claim 28, comprising cutting said sealing arrangement such that a second tab extends beyond said first part.

33. A method according to claim 32, wherein the second tab extends from said main part opposite the first mentioned tab.

34. A method according to claim 32, wherein the second tab is formed from the second membrane.

35. A method according to claim 29, wherein the second tab is formed from the third portion of the second membrane.

36. A method of forming a sealing arrangement comprising providing a first membrane and a second membrane, said second membrane comprising first and second portions, arranging the first portion and the first membrane in face to face contact and providing the second portion with an aperture.
